(19) United States
(12) Patent Application Publication
(10) Pub. No.: US 2006/0256741 A1
(43) Pub. Date: Nov. 16, 2006

(54) Frame transmission method in a multi-hop connection using a MAC address of data link layer identifier

(75) Inventor: Masanori Nozaki, Osaka (JP)

Correspondence Address: VENABLE LLP, P.O. BOX 34385, WASHINGTON, DC, 20043-9998, US

(73) Assignee: Oki Electric Industry Co., Ltd., Tokyo (JP)

(21) Appl. No.: 11/429,275

(22) Filed: May 8, 2006

(30) Foreign Application Priority Data
May 12, 2005 (JP) 2005-140300

(51) Int. Cl. H04B 7/005; H04L 12/56

(52) U.S. Cl. 370/278; 370/400

(57) ABSTRACT

A frame transmission method is provided in which a multi-hop connection is established between access points and wireless terminals connected to the access points by using only a MAC address, the identifier of the data link layer (Layer 2). Various control frames are transmitted between access points to acquire the network topology. Over the unicast/broadcast communication system, data may be relayed and transferred in the form of frames from a wireless terminal connected to an access point to another wireless terminal via the optimum multi-hop path.

### BACKGROUND OF THE INVENTION

1. Field of the Invention

The present invention relates to a multi-hop wireless communications system composed of plural access points, and especially to, for example, a frame transmission method, a topology acquisition method and a wireless communication method.

2. Description of the Background Art

In a wireless communications system applicable to a multi-hop network, the network is composed of plural wireless stations having relay functions, and packets are relayed from one wireless station to another wireless station adjacent thereto, thus making it possible to transfer the packets to a wireless station which the radio wave from the one wireless station cannot directly reach. By applying such multi-hop relay functions to a wireless local area network (LAN) and connecting its access points (APs), i.e. the base stations of the wireless LAN, by means of radio waves, it is possible to reduce the cost in installing a wired network that has up to now been considered necessary for installing access points.

As such a multi-hop wireless LAN, a system is known by Yasunori Owada, et al., “A Study of the Architecture for Multi-Hop Wireless LAN (M-WLAN)”, The Institute of Electronics, Information and Communication Engineers (IEICE), Technical Report of IEICE, IN2004-1121, pp.25-30, November 2004. In this system, at an access point that is a base station, a wireless LAN frame received from a wireless terminal is first converted into an Ethernet (TM) frame and capsulized into an IP/UDP (Internet Protocol/User Datagram Protocol) packet and then multi-hop relayed to a destination access point.

To the multi-hop relay system, as its routing protocol applied is the Optimized Link State Protocol (OLSR) that is Recommendation RFC3626 standardized by the Internet Engineering Task Force (IETF). The OLSR protocol is a proactive-type protocol in which the optimum routing path is calculated based on the whole network topology obtained by periodical transmission of control packets between adjacent wireless stations.

In the above-described system, the transfer of the wireless LAN frame is implemented by converting the wireless LAN frame into the Ethernet frame and then capsulizing it into the IP/UDP packet. In this system, however, there are problems that the overhead increases due to the capsulization and the throughput degrades due to a processing delay in capsulization and decapsulization.

On the other hand, as a method of relaying wireless LAN frames on wireless media, there is another method using the WDS (Wireless Distribution System) frame defined by the IEEE (Institute of Electrical and Electronics Engineers) 802.11. The WDS frame includes the fields of ordinary source MAC (Media Access Control) address (SA) and destination MAC address (DA) as well as next receiver access point MAC address (RA) and transmitter access point MAC address (TA). Describing the MAC address of an access point to be relayed in the RA address field establishes the wireless relay between the access points.

However, the conventional relay method using WDS frames requires the static setting of the access point MAC address to be relayed, and therefore the access point is merely equipped with a simple flooding function, i.e. the function of resending wireless frames. The resending of wireless frames by simple flooding might cause the transmission frequency band by other wireless terminals to be restricted, thus giving rise to the throughput degradation.

### SUMMARY OF THE INVENTION

It is an object of the present invention to provide an improved multi-hop wireless relay method that is able to dynamically establish a multi-hop path by means of WDS frames and transfer only necessary frames.

To solve above-described problems, the present invention provides an implementation of the multi-hop routing with the MAC address serving as an identifier for routing by using only on the basis of information of the data link layer (Layer 2), such as the physical address, MAC address.

A wireless frame transmission method according to an aspect of the present invention comprises transmitting and receiving various control frames between access points to grasp the network topology, and transferring on a multi-hop relay data from a wireless terminal connected to an access point to another wireless terminal by means of the unicast/broadcast communication system.

According to another aspect of the present invention, a multi-hop routing method decentralizes the traffic load by selecting an uncrowded path when plural paths having the same number of hops are available.

According to the present invention, it is possible to realize the multi-hop connection between access points and/or wireless terminals connected to the access points by using only the MAC address that is the identifier of the data link layer (Layer 2), and thus decrease the overhead which would otherwise be caused by capsulization and was considered necessary up to now. When plural paths are available which are the same as each other in number of hops to a destination access point, the number of wireless terminals connected to the access points existing on the paths is counted, thus making it possible to select an uncrowded path so as to decentralize the traffic load.

### BRIEF DESCRIPTION OF THE DRAWINGS

The objects and features of the present invention will become more apparent from consideration of the following detailed description taken in conjunction with the accompanying drawings in which:

FIG. 1 is a schematic functional diagram showing an access point included in a wireless network according to an illustrative embodiment of the invention;

FIG. 2 schematically shows a network configuration according to the illustrative embodiment of the invention;

FIG. 3 shows the procedure to make a routing table according to the embodiment;

FIG. 4A shows the function of Hello frames transmitted and received in the embodiment;

FIG. 4B shows in a sequence chart how Hello frames are transmitted and received in the embodiment;

FIG. 5A shows the function of the frames of advertisement of an MPR set nodes according to the embodiment;

FIG. 5B shows in a sequence chart how the advertisement of an MPR set nodes proceeds according to the embodiment;

FIG. 6A shows the function of the frame of advertisement of a topology control message according to the embodiment;

FIG. 6B shows in a sequence chart how the advertisement of a topology control message proceeds according to the embodiment;

FIG. 7A shows the function of the frame of advertisement of a MAC address management table according to the embodiment;

FIG. 7B shows in a sequence chart how the advertisement of a MAC address management table proceeds according to the embodiment;

FIG. 8A shows the function of the unicast frame transferred according to the embodiment;

FIG. 8B shows in a sequence chart how the unicast frame is transferred according to the embodiment;

FIG. 9A shows the function of the broadcast frame transferred according to the embodiment;

FIG. 9B shows in a sequence chart how the broadcast frame is transferred according to the embodiment;

FIG. 10 is a schematic functional diagram, similar to FIG. 1, showing an access point included in a wireless network according to an alternative embodiment of the invention;

FIG. 11 schematically shows a network configuration, similarly to FIG. 2, according to the alternative embodiment of the invention; and

FIGS. 12A, 12B and 12C show the structure of the tables used in the alternative embodiment.

### DESCRIPTION OF THE PREFERRED EMBODIMENTS

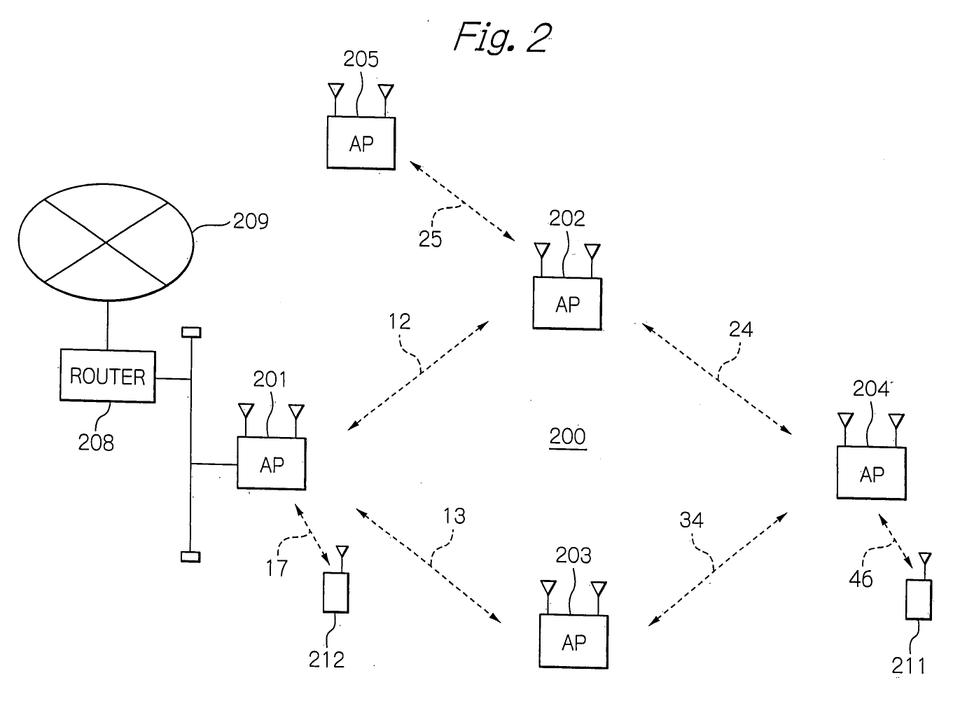

At first, with reference to FIG. 2, showing an example 200 of the wireless network configuration according to the illustrative embodiment of the invention, the network 200 is composed of a plurality of, e.g. five, access points (APs) or radio stations 201, 202, 203, 204 and 205. Each of the four access points 202, 203, 204 and 205 includes the frame transfer function of receiving a frame from a wireless terminal and transferring the frame to another of the access points which is adjacent thereto so as to transfer the frame to an addressed access point which the radio wave emitted therefrom cannot reach directly. The access point 201 is provided with the same frame transfer function as the access points 202, 203, 204 and 205, and further a gateway function to a wired network, such as an IP (Internet Protocol) network 209. The network 200 also includes a router 208 which is connected with the IP network 209 such as Internet or Intranet and relays IP packets. In the network 200, there are included a plurality of, e.g. two, wireless terminals 211 and 212 which are able to be connected with any of the access points 201 through 205 on wireless or radio wave media.

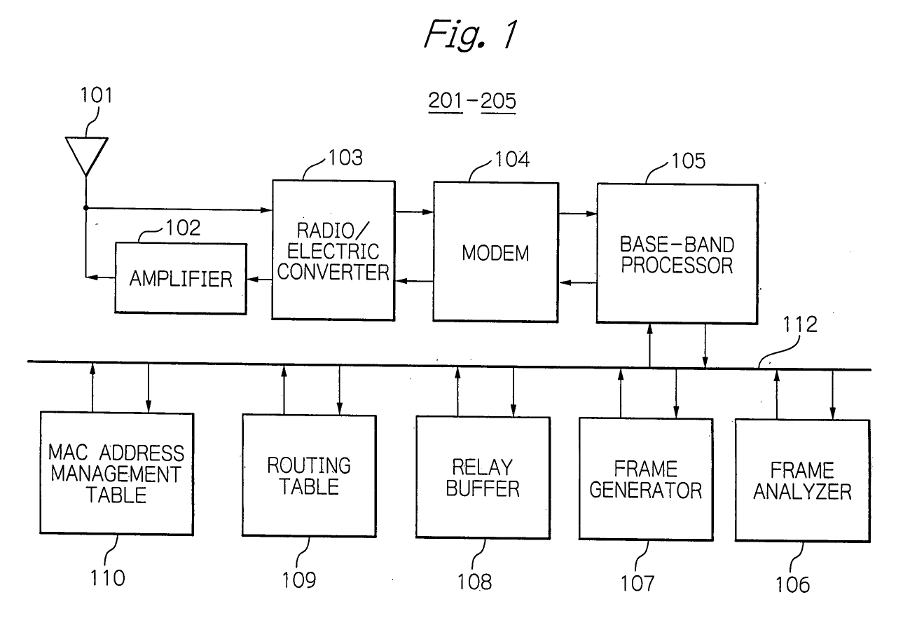

In FIG. 1, one 201 of the access points 201 through 205 is shown in a schematic functional diagram in the wireless network 200 according to the illustrative embodiment of the invention. The remaining access points 202-205 may be the same in structure as the access point 201. The access point is composed of an antenna 101 for emitting a radio wave, and an amplifier 102 which is interconnected to the antenna 101, and amplifies the strength of signals to be transmitted by the antenna 101. The access point 201 also includes a radio frequency-electric signal converter 103 which is interconnected to the antenna 101 and the amplifier 102, and converts the radio frequency signal to the electric signal and vice versa and also shifts their frequency bands. In the description, signals are designated with the reference numerals of the connection on which they appear.

The access point 101 is also comprised of a modulator/demodulator or modem 104 which is interconnected to the radio-frequency-electric signal converter 103, and adapted for modulating and demodulating signals with the spread spectrum scheme. To the modulator/demodulator 104, interconnected is a base-band processing unit 105 which converts the radio frequency to the base-band frequency, lower than the radio frequency, and controls the interface of a bus 112 to the other functional units included in the access point 201.

To the bus 112, interconnected are a frame analyzer 106 which analyzes the header field of a frame received from another access point, and a frame generator 107 which generates a control information frame and a WDS (Wireless Distribution System) frame for relaying the received frame to the next access point. Also to the bus 112, interconnected are a relay buffer 108 which temporarily holds a frame to be relayed when received a frame addressed to the adjacent access point or a frame addressed to a wireless terminal presently connected to the own access point, a routing table 109 which holds routing information, for example, one-hop adjacency table, etc., for relaying the received frame to a desired access point, and a MAC (Media Access Control) address management table 110 listing the MAC addresses of the wireless terminals connected to the access points.

Further, these above-described constituent elements, i.e. the frame analyzer 106, frame generator 107, relay buffer 108, routing table 109 and MAC address management table 110 may be implemented by made of operational devices such as a general purpose microprocessor unit (MPU) and storage devices such as semiconductor memories and/or hard discs.

The illustrative embodiment aims at implementing the multi-hop relay between access points by using the MAC address as an identifier of the data link layer, specifically Layer 2, only. For this aim, first of all, it is required to make a routing table utilizing the MAC address.

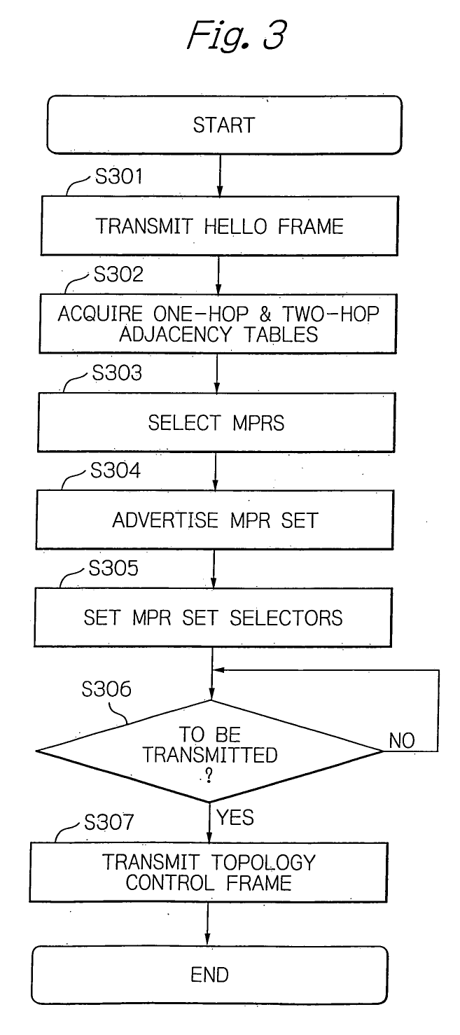

FIG. 3 is a flow chart that shows an exemplified procedure to make a routing table, i.e. path information, according to the illustrative embodiment of the invention. The exemplified procedure shown in the figure is directed to the access point 204. First, the access point 204 sends a Hello frame to try the detection of its adjacent access points (S301).

Now, the Hello frame will be described. For example, the Optimized Link State Protocol (OLSR) utilizes control information named Hello packet for giving the information of the access point itself and its adjacent access points to other access points, and acquiring from the other access points the information of the adjacent and two-hop distant access points from the own access point. Hereinafter, communication carried out between the own access point and its adjacent access point is referred to as one-hop communication, and the communication carried out between the own access point and an access point not adjacent thereto via one of its adjacent access points is called two-hop communication. In the embodiment of the invention, the identifier, or MAC address, of the data link layer (Layer 2) is used as control information like the Hello packet of OLSR protocol, so that the control information is called Hello frame.

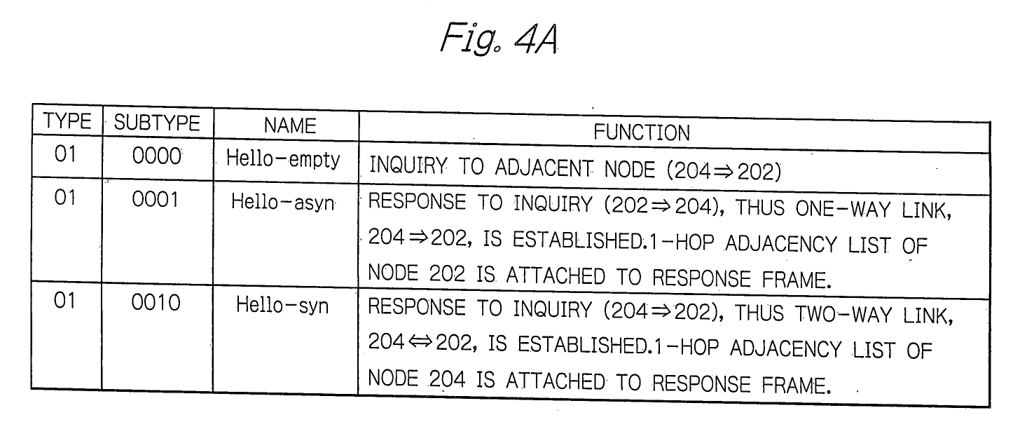

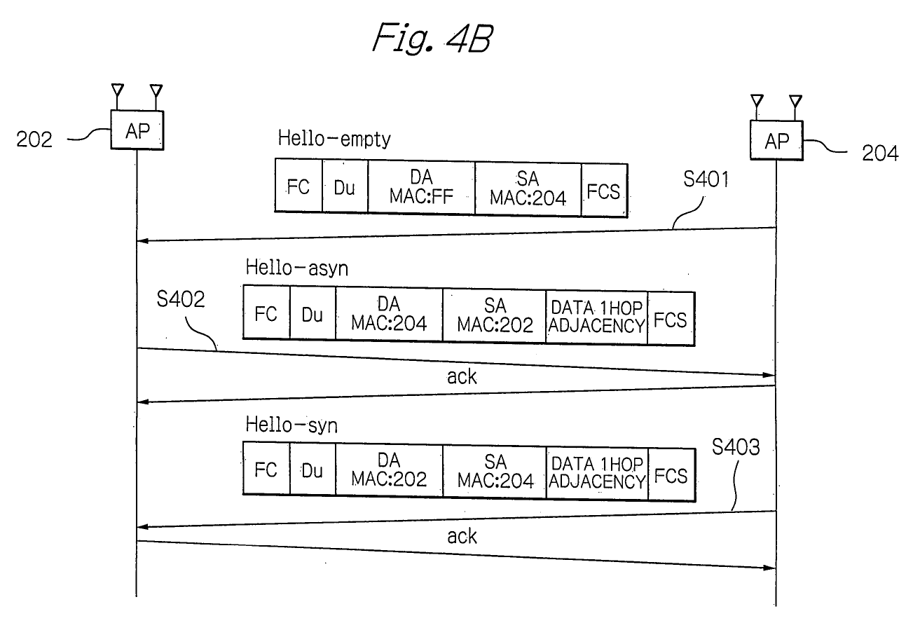

In the embodiment of the invention, three kinds of Hello frames, Hello-empty frame, Hello-asyn frame and Hello-syn frame, are provided as inquiry/response frames. The function of the three kinds of frames and the transmission procedure of these frames between access points will be understood from FIGS. 4A and 4B, respectively.

For identifying the three kinds of Hello frames from each other, use is made of the reserved subfield of the identifier (Type value 01) of the Frame Control (FC) field of the existent MAC frame. With the illustrative embodiment, the Subtype binary values 0000-0010 are used for identifying the three Hello frames, respectively. First, the access point 204 sends the Hello-empty frame including two addresses, i.e. the Destination Address (DA) as a broadcast address, FF:FF:FF:FF:FF:FF, and the Source Address (SA) (S401, FIG. 4B). The Hello frames additionally include Frame Control (FC), Duration (Du) and Frame Check Sequence (FCS) fields as shown in FIG. 4B.

The access point 202, when received the Hello-empty frame, attaches the own one-hop adjacency table to the frame. When attaching the table, the access point 202 adds, if the MAC address of the access point 204 is not described yet in its own one-hop table, the MAC address of the access point 204 to its one-hop adjacency table. Thereafter, the access point 202 sends the Hello-asyn frame back to the source access point 204 (S402). The one-hop adjacency table includes a list of the MAC addresses of the neighboring access points with which one-hop communication is possible obtained by exchanging the Hello frames.

Next, after receiving the Hello-asyn frame, the access point 204 now sends the Hello-syn frame including its own one-hop adjacency table to the destination access point 202 (S403). Likewise to step 402, if the MAC address of the access point 202 is not described yet in its own one-hop adjacency table, the access point 204 adds the MAC address of the access point 202 to its one-hop adjacency table. Each access point is thereby able to detect the access points that are not included in its own one-hop adjacency table but in the one-hop adjacency tables of its adjacent access points. Because these detected access points are able to relay frames in a two-hop way via the adjacent access points, the MAC addresses of these detected access points are registered in its own two-hop adjacency table managed by the own access point.

For example, in FIG. 2, if the access points 201 and 205 are detected as adjacent access points by the access point 202, these access points 201 and 205 can be added to the two-hop adjacency table of the access point 204. According to the Hello frame transmission procedure described above, each access point is able to obtain its own one-hop adjacency table and two-hop adjacency table (S302, FIG. 3).

Next, the access point uses the one-hop adjacency table and two-hop adjacency table thus obtained to select another access point which is able to relay the broadcast frame (S303). That access point corresponds to a Multiple Point Relay (MPR) node of the OLSR protocol. The criterion for selecting the MPR node relies upon reducing, when the frame is transmitted to all access points, the amount of repetitions of the frame transmission as little as possible. For example, in FIG. 2, for relaying the broadcast frame sent from the access point 204, there are two access points 202 and 203 as candidates for the relay node. However, if the access point 203 is selected as an MPR node, it can relay the frame to the access point 201 in a one-hop way, but not to the access point 205 in a one-hop way.

On the other hand, if the access point 202 is selected as an MPR node, then it can relay the frame to both access stations 201 and 205 in a one-hop way. Therefore, it is more preferable to select the access point 202 as an MPR node than to select the access point 203, and it is thus possible to reduce the amount of repetitions of the frame transmission. Thus, as an MPR node for the access point 204, the access point 202 will be selected. In this selection method, the Willingness to the MPR node proposed by the OLSP protocol may be used in calculation. The list of selected MPR nodes is advertised as an MPR set nodes to the adjacent access points. Hereinafter, in the embodiments of the invention, to advertise means to transmit information for notification (S304). There are two methods for advertising the MPR set nodes, one is a broadcast method and the other is a unicast method.

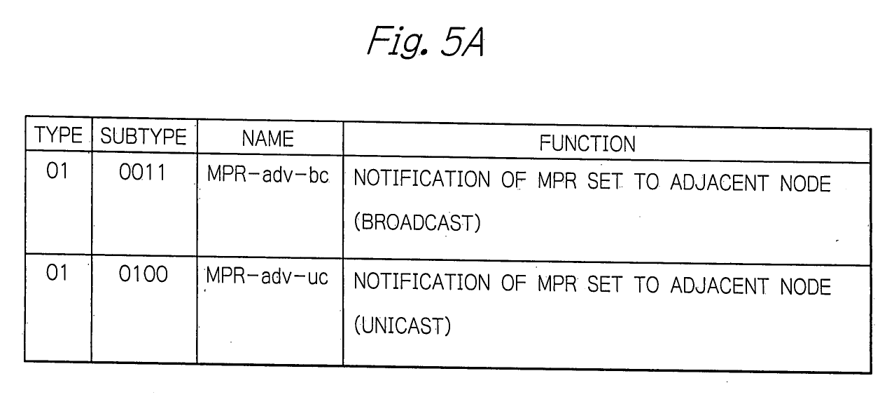

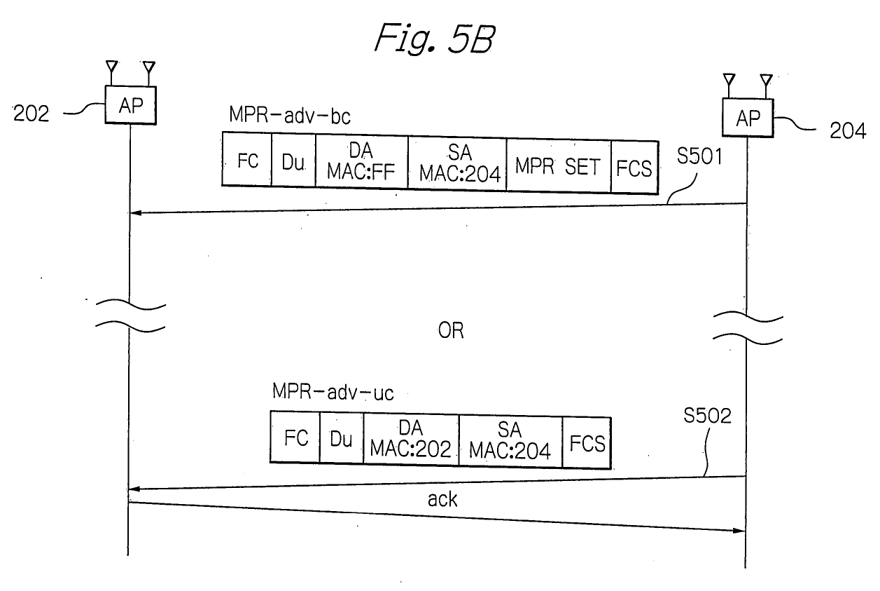

FIGS. 5A and 5B show the function of the frame and the advertisement procedure of an MPR set nodes by the broadcast method and the unicast method, respectively. There are two methods for advertising of the MPR set nodes, a broadcast method and a unicast method. In the broadcast method, an MPR-adv-bc frame bearing the broadcast address in its DA field, the own MAC address in its SA field and the MPR set nodes in its data field is formed and broadcast (S501).

The access point, when received the MPR-adv-bc frame, references the MPR set nodes described in the data field. The access point newly adds, if its own MAC address is included in the set, the MAC address described in the SA field of the received frame to the MPR set selectors. The broadcast frame transmitted from the access point described in the MPR set selectors is transmitted again by that access point.

For example, in FIG. 5B, when the access point 202 has received the MPR-adv-bc frame sent from the access point 204, the access point 202 references the MPR set nodes described in the data field. If the MAC address of the access point 202 is included in the set, the access point 202 adds the MAC address of the access point 204 to the MPR set selectors of the access point 202. After that, by referencing the MPR set selectors, the broadcast frame transmitted from the access point 204 is transmitted by the access point 202 again.

On the other hand, in the unicast method, an MPR-adv-uc frame bearing the MAC address described in the MPR set nodes in its DA field, the own MAC address in its SA field is formed and then transmitted. In this case, the MPR-adv-uc frame does not include a data field, and the access point having received the frame adds the MAC address described in its SA field to the own MPR set selectors of the access point. For example, in FIG. 5B, after receiving the MPR-adv-uc frame sent from the access point 204, the access point 202 adds the MAC address described in the SA field to the own MPR set selectors. In the unicast method, the unicast frame should be transmitted to each access point described in the MPR set nodes, and the reception of ACK frame sent from each access point is required. However, as a result, higher reliability will be achieved in data transmission and reception.

By using either of the two methods described above, the adjacent points will provide its MPR set selectors (S305). Next, the MPR set selectors is advertised to all access points.

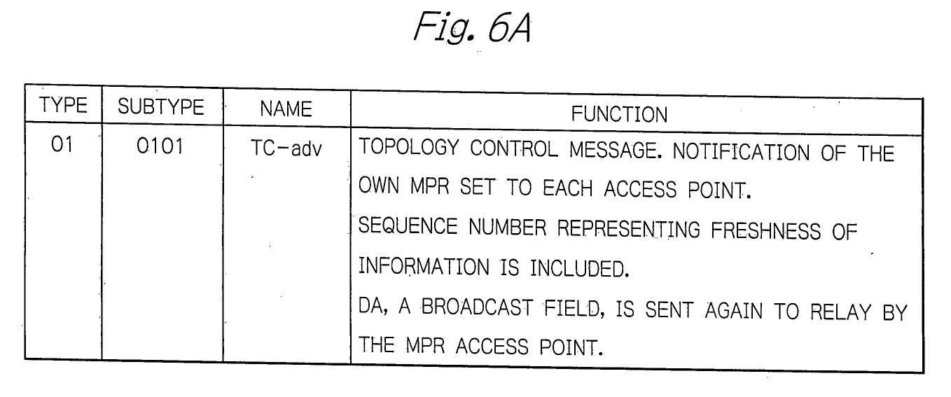

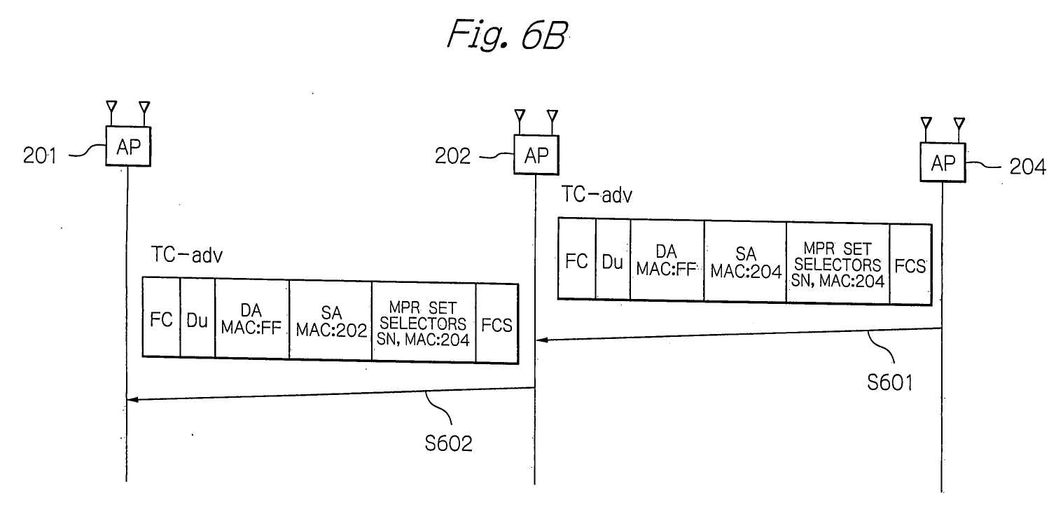

FIGS. 6A and 6B show the function of the topology control frame generated by an access point and its transmission procedure in this aspect, respectively. The contents to be advertised consist of the MPR set selectors obtained at step S305, the own MAC address of the access point and the sequence number representing the freshness of the information, etc. These contents are broadcast in the form of topology control frame (TC-adv) in step S307.

In the TC-adv frame, the broadcast addresses are set in its DA field and the own MAC address of the access point is set in its SA field (S601). For example, in FIG. 6B, when the access point 202 has received the TC-adv frame from the access point 204, the access point 202 extracts the MPR set selectors of the access point 204 described in the data field, and holds the set in its table. As the access point 202 is registered as an MPR node of the access point 204, the received TC-adv frame is successively relayed and resent (S 602). At this point of time, the SA field of the frame is rewritten from the MAC address of the access point 204 to the MAC address of the access point 202. The TC-adv frame is periodically transmitted at a predetermined interval, for example, once per ten seconds. Further, when the MPR set nodes is received (S304) from the adjacent access point and the MPR set selectors is revised, the TC-adv frame is successively transmitted at once (S306).

By the advertisement like this, whole sets of MPR node of all the access points can be collected. As these sets of MPR node represent the interconnecting relation of all access points, it is now possible to acquire the network topology formed by all the access points. It is thus also possible to determine the optimum path to the desired access point, on which path information is stored in the routing table 109. Based on the routing table, the access point determines whether to relay the received frame. In the routing table, only the MAC addresses of the access points are registered, and it is therefore possible to make routing to the desired access point, and not to transfer the frame to the wireless terminal connected to that access point directly.

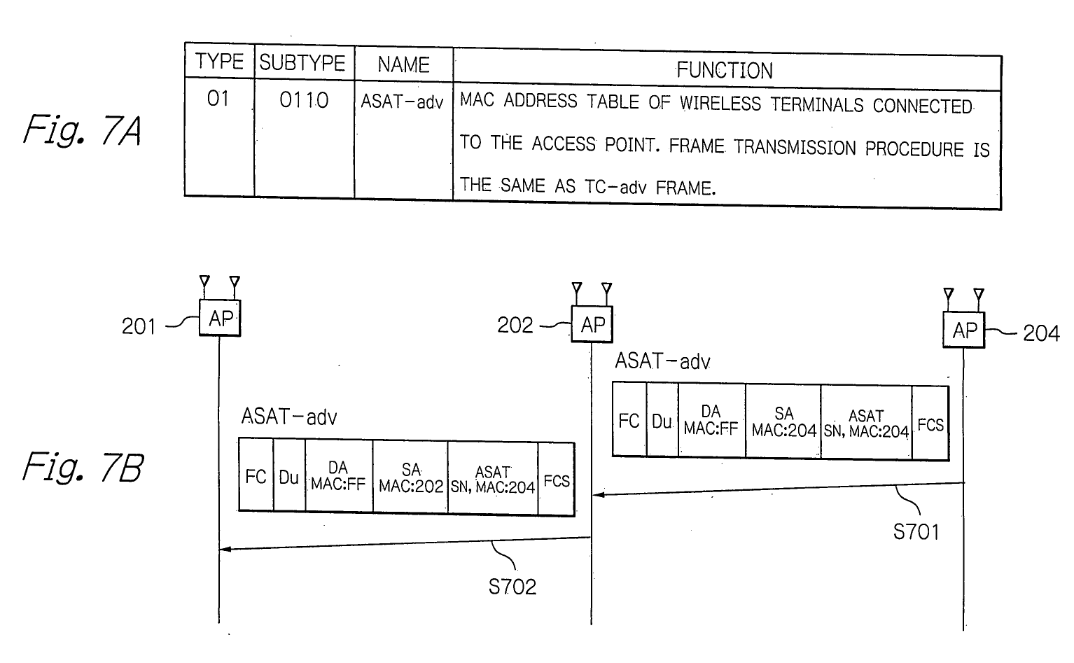

Therefore, another information is needed that shows to which access point the wireless terminal is being connected at present. The information is referred to as a MAC address management table, and is advertised to each access point by means of MPR broadcasting of the current connecting relation of each access point with its wireless terminals. FIGS. 7A and 7B show the function of the address table and its transmission procedure in this aspect, respectively.

The contents to be advertised consiss of the list of the MAC addresses of the wireless terminals connected at present to the own access point, the own MAC address of the access point and the sequence number representing the information freshness, etc. These contents are broadcast in the form of ASAT frame (ASAT-adv). In the ASAT-adv frame, the broadcast addresses are set in its DA field and the own MAC address of the access point is set in its SA field (S701).

For example, in FIG. 7B, when the access point 202 has received the ASAT-adv frame from the access point 204, the access point 202 extracts the MAC address management table of the access point 204 described in the data field, and adds the data of the table thus extracted to its own MAC address management table 110. As the access point 202 is registered as an MPR node of the access point 204, the received ASAT-adv frame is successively resent (S 702). The advertisement of the MAC address management table like this allows all the MAC address management tables 110 of all the access points to be collected. Referencing the MAC address management table, it is now possible to determine to which access point the frame addressed to the recipient wireless terminal should be transferred.

Through the operation described above, it is possible to obtain the MAC address management table 110 showing how the wireless terminals are being connected to which access point, and the routing table 109 showing how the frame should be transferred to which access point for relaying it to the desired access point.

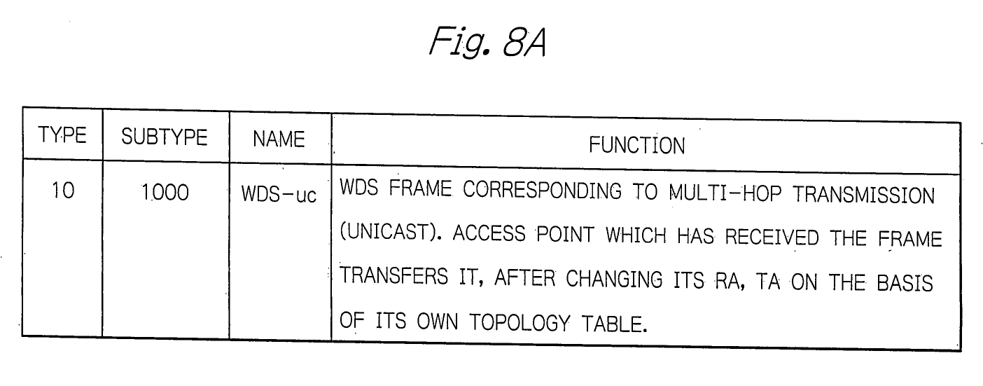

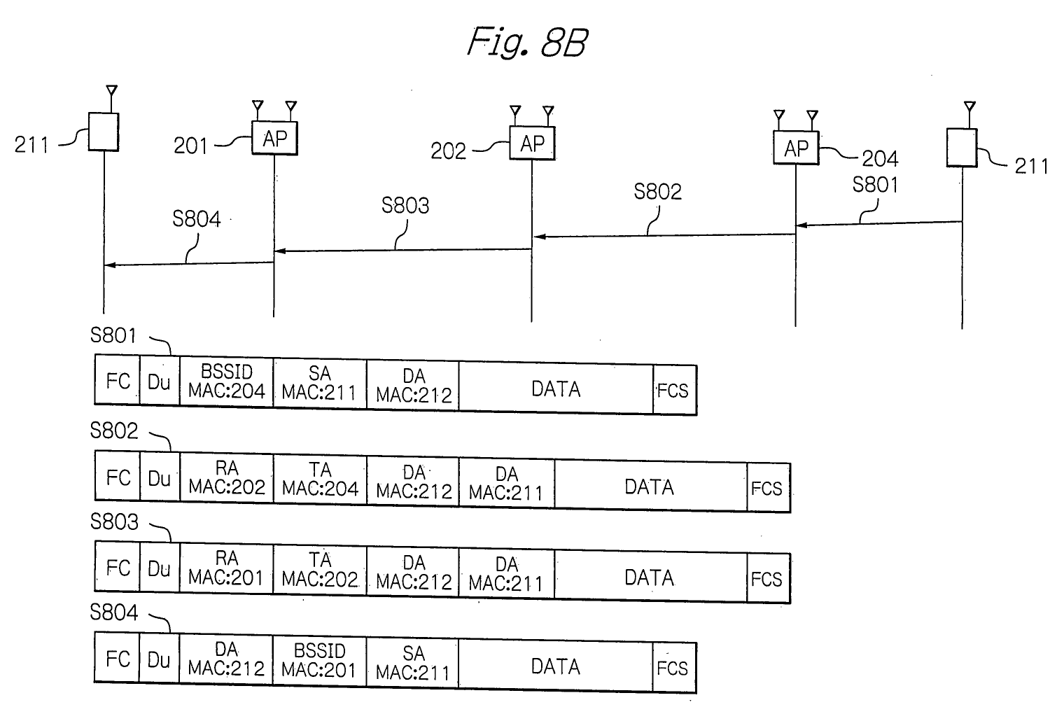

Well, with reference to FIGS. 8A and 8B, description will be made on the procedure for relaying the frame between two wireless terminals by means of these tables. FIGS. 8A and 8B respectively show the function of the frame and the procedure of relaying the frame from the wireless terminal 211 to the wireless terminal 212. First, the wireless terminal 211 transmits the frame wherein the MAC address of the wireless terminal 212 is set in its DA field, the MAC address of the wireless terminal 211 is set in its SA field and the MAC address of the access point 204 is set in its Basic Service Set Identifier (BSSID) as the network identifier (S801).

After receiving the frame from the wireless terminal 211, the access point 204 retrieves the wireless terminal 212 described in the DA field to which access point it is registered from the MAC address management table 110. As a result of the retrieval, it is known that the wireless terminal 212 is connected to the access point 201.

Now, the access point 204 retrieves the access point to which the frame should be transferred for relaying the frame to the access point 201 from the routing table 109. At a result, it is known that the access point 202 is suitable for relaying the frame. The WDS-uc frame to be transferred to the access point 202 has its format similar to the WDS frame. However, the value of its Subtype is changed or updated to discriminate itself from the existing WDS frame. In the address fields of the address frame, there are set the MAC address of the access point 202 in the RA field, the MAC address of the access point 204 in the TA field, the MAC address of the wireless terminal 212 in the DA field and the MAC address of the wireless terminal 211 in the SA field (S802).

The access point 202, when received the WDS-uc frame, retrieves the wireless terminal 212 described in the DA field to which access point it is connected from its own MAC address management table 110. At a result of the retrieval it will be known that the wireless terminal 212 is connected to the access point 201. Similarly, the access point 202 retrieves a path to the access point 201 from its own routing table 109. It will become aware of the access point 201 being the adjacent access point in a one-hop way. Then, the access point 202 changes or updates the addresses with the MAC address of the access point 201 in the RA field and the MAC address of the access point 202 in TA field, and resends the frame (S803).

The access point 201, which has finally received the frame, knows that the wireless terminal 212 is registered to its own MAC address management table, and then transmits the frame converted to the ordinary infra-mode frame to the wireless terminal 212 (S804).

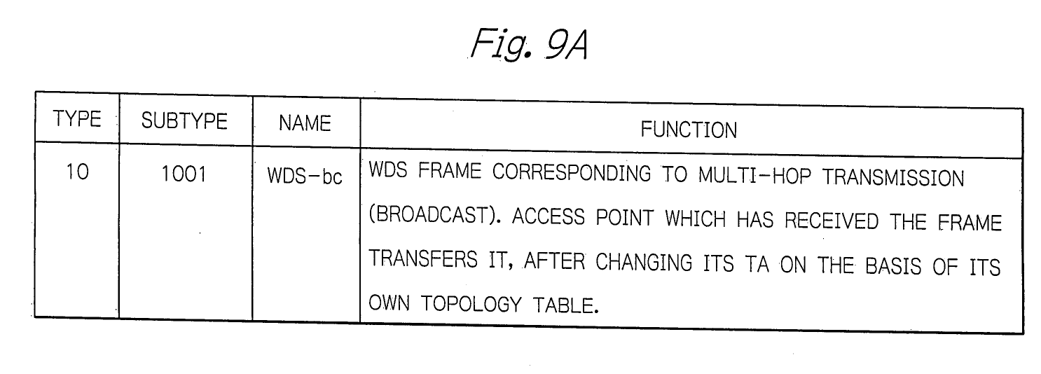

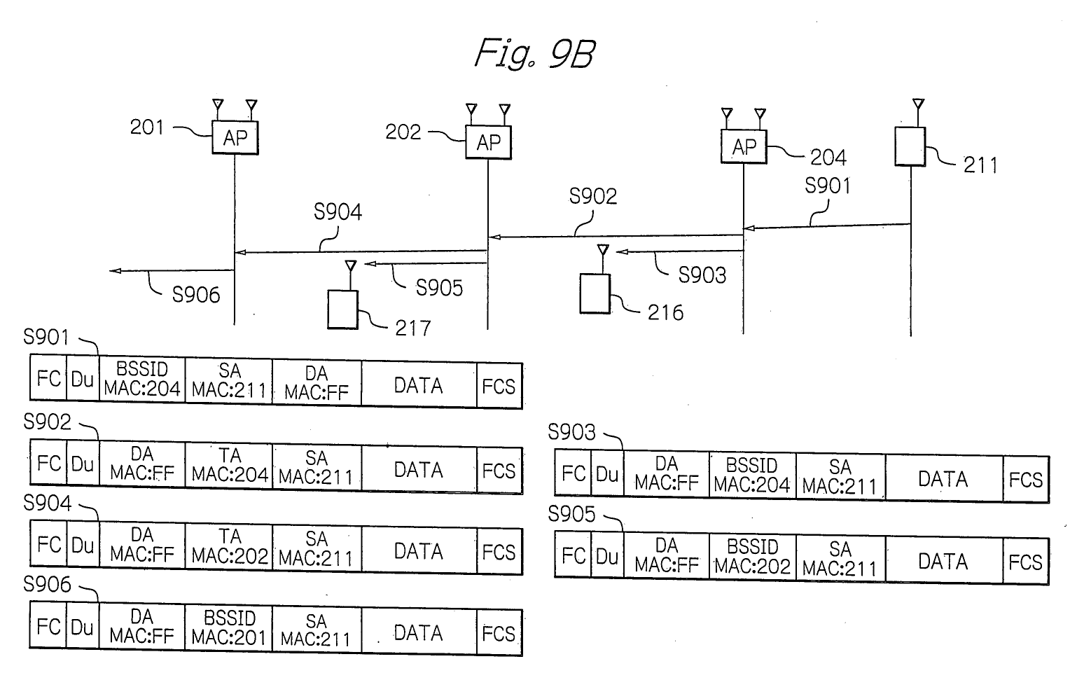

Further, the procedure for transmitting a broadcast frame from the wireless terminal addressed to all of the other wireless terminals will be described with reference to FIGS. 9A and 9B. FIGS. 9A and 9B show the function of the frame and the procedure for relaying the broadcast frame from the wireless terminal 211, respectively. First, the wireless terminal 211 transmits the broadcast frame in which the broadcast address is set in its DA field, the MAC address of the wireless terminal 211 is set in its SA field and the MAC address of the access point 204 is set in its BSSID field as the network identifier (S901).

The access point 204 which has received the frame from the wireless terminal 211 establishes the WDS-bc frame, in which the MAC address of the access point 204 in its TA field for broadcasting it to the other access points, and then transmits it (S902).

In addition, the access point 204 transmits the broadcast frame again to a wireless terminal 216 connected thereto (S903). The access point 202 is set as an MPR node of the access point 204. Therefore, the access point 202 changes the MAC address described in the TA field of the broadcast frame received from the access point 204 to the MAC address of the own access point, and then transmits again the frame thus updated (S904). Similarly to step S903, the access point 202 transmits the broadcast frame again to a wireless terminal 217 connected thereto (S905).

The access point 201 which has received the broadcast frame from the wireless terminal 202 retransmits the broadcast frame to the wireless terminals connected to the own access point (S906).

Through the above-described operation, it is possible to establish the multi-hop routing through the data link layers (Layer 2) using MAC addresses, and to relay the unicast/broadcast frames between the wireless terminals very efficiently. Further, in the illustrative embodiment of the invention, the wireless channel used between the wireless terminal and the access point is the same channel used between the access points. Alternatively, different channels may be used, and in that case it is naturally possible to improve the traffic throughput due to freedom from mutual interference.

As described above, with the illustrative embodiment of the invention, it is possible to establish a multi-hop connection between the access points and also the wireless terminals connected to the access points only by using the MAC addresses, i.e. the identifiers of the data link layers (Layer 2), and to reduce the overhead due to capsulization, etc., which have been considered necessary up to now.

Well, reference will be made to FIG. 11 showing a network configuration 200a according to an alternative embodiment of the invention. The wireless network 200a shown in FIG. 11 additionally includes an access point or radio-station 206 and wireless terminals 210, 213, 214 and 215. The additional wireless terminal 210, 213, 214 and 215 are presently connected to the access points 204, 202, 206 and 201, respectively, and the two wireless terminals 211 and 212 are now connected to the access point 203. In the figure, dotted arrows indicate wireless or radio wave connections, similarly to FIG. 2.

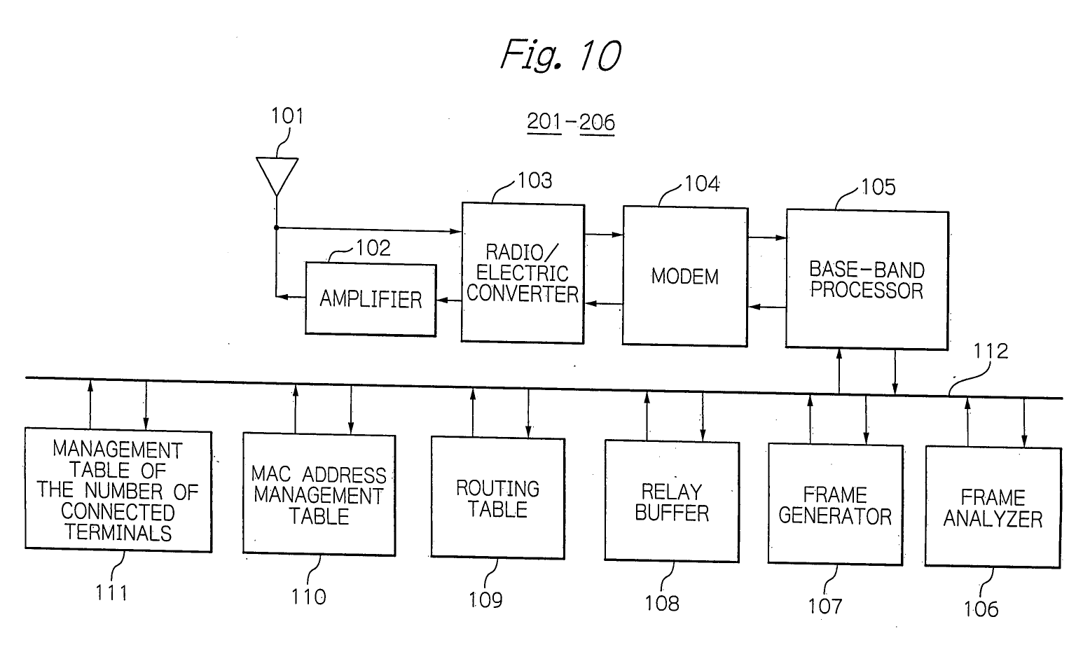

FIG. 10 is a schematic functional diagram showing one 201 of the access points 201-206 included in the wireless network 200a according to the alternative embodiment. In addition to the components shown in FIG. 1, the access point 201 includes a management table of the number of connected terminals 111. The remaining access points 202-206 may be the same in structure as the access point 201. Like elements are designated with the same reference numerals. At each access point, the MAC address management table 110 and the routing table 109 are already provided by the same procedures as described in respect of the illustrative embodiment shown in FIG. 1.

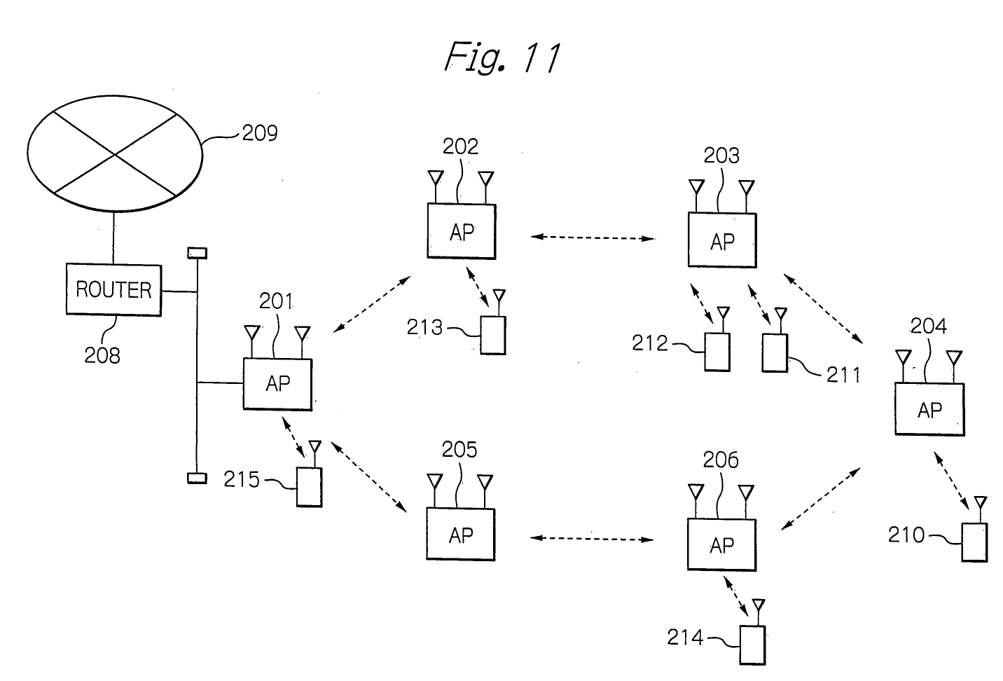

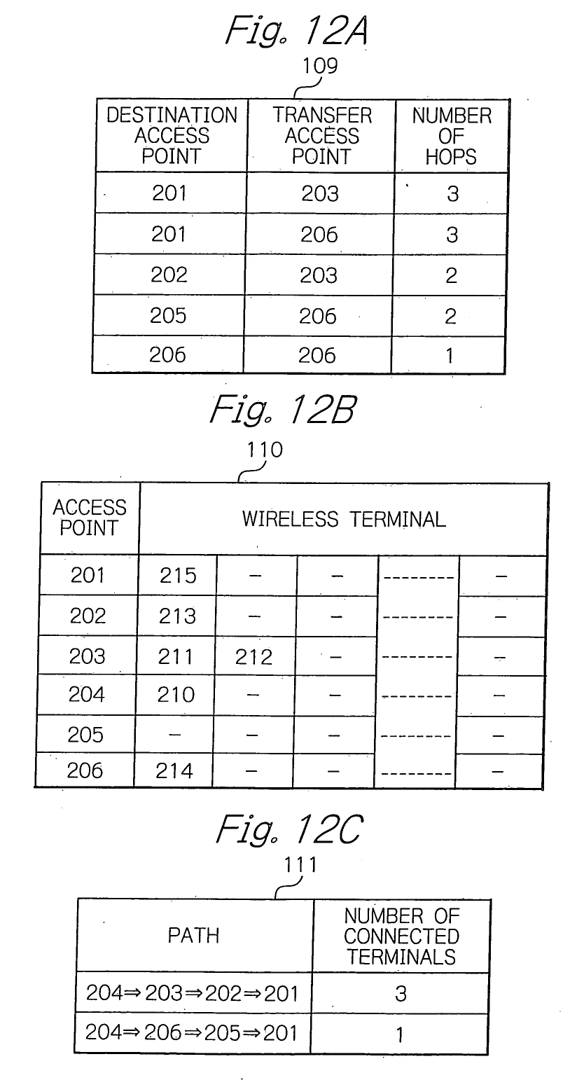

FIGS. 12A, 12B and 12C show the structures of the tables provided at the access point 204, specifically the routing table 109, the MAC address management table 110 and the management table of the number of connected terminals 111, respectively. In the routing table 109, the access points which have the least number of hops needed for relay to the destination access points are registered as the transfer access points. In the instant alternative embodiment, for example, when it is desired to send a frame to the access point 205, the frame will be transferred to the access point 206 so that the frame can reach the destination access point 205 on a two-hop relay.

Consider a frame being sent from the wireless terminal 210 to the wireless terminal 215. The access point 204, when received the frame from the wireless terminal 211, references its MAC address management table 110 to thereby detect that the wireless terminal 215 is connected to the access point 201.

Next, the access point 204 references its routing table 109, and then determines to which access point the frame should be transferred in order to relay the frame to the access point 201. In this case, two possible paths are found to the access point 201. One is a route via the transfer access point 203, and the other is a route via the transfer access point 206. Both of them are the same in number of hops, i.e. three needed for relay. Therefore, in such a case wherein there are plural paths having the same number of hops, some criterion is necessary for determining to which access point the frame should be transferred.

As a determination criterion, or metric, other than the number of hops generally, the bandwidth, the transfer delay or the bit-error rate of a link may be used. However, in order to use these parameters, particular measurement means will be required, thus causing additional cost.

In the alternative embodiment, by utilizing the MAC address management table 110 already obtained as a metric for path selection, it is possible to prevent such cost from increasing. Specifically, by counting or determining the number of wireless terminals connected to the access points existing on each path, one of the paths that has the least sum of the number of wireless terminals is selected with priority. For example, there are two paths from the access point 204 to the access point 201, one passing the access points 204, 203, 202 and 201 in this order, and the other passing the access points 204, 206, 205 and 201 in this order. The former path passes the access points 203 and 202, so that the number of the wireless terminals connected to them is three. By contrast, the latter path passes the access points 206 and 205, so that the number of the wireless terminals connected to them is one. The number of wireless terminals existing on each path is described in the management table of the number of connected terminals 111.

By referencing the management table of the number of connected terminals 111, the access point 204 learns that the path from the access point 204 through the access points 206 and 205 to the access point 201 has the less number of the wireless terminals connected to it, and therefore determines that the traffic on the path with such less wireless terminals is not crowded. Resultantly, the access point 204 uses this path to transfer the frame from the wireless terminal 211 to the access point 206.

Through the procedures described above, if there are plural paths having the same number of hops needed to relay frames to a destination access point, it is possible to expect the traffic status of each path, and then select the optimum transfer access point.

The entire disclosure of Japanese patent application No. 2005-140300 filed on May 12, 2005, including the specification, claims, accompanying drawings and abstract of the disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A method of transmitting a frame in a multi-hop wireless network comprising a plurality of access points, each of the plurality of access points having a function of relaying a frame, comprising the steps of:
transmitting and receiving an inquiry frame and a response frame to and from the plurality of access points to detect a connection status between first one of the plurality of access points and second one of the access points which is adjacent to the first access point;
transferring first information on the detected status between the plurality of access points; and
detecting, on a basis of the transferred first information, third one of the plurality of access points which a radio wave from the first access point can reach in a one-hop way or fourth one of the plurality of access points which the radio wave can reach in a two-hop way.

2. The method in accordance with claim 1, further comprising the steps of:
forming, based on second information on the third and fourth access points detected, a one-hop adjacency table and a two-hop adjacency table;
selecting a set of relaying access points via which a broadcast frame from the first access point can be relayed to an intended destination access point with the least number of relaying access points; and
notifying the relaying access points of the selected set of relaying access points on a broadcast control frame or a unicast control frame.

3. The method in accordance with claim 1, further comprising the steps of:
forming, based on second information on the third and fourth access points detected, a one-hop adjacency table and a two-hop adjacency table;
selecting a relaying access point which relays a broadcast frame from the first access point to an intended destination access point;
advertising third information on a physical address of a wireless terminal connected to any of the plurality of access points on a broadcast frame via a path including the selected relaying access point; and
forming a physical address management table representing a connection status between any of the plurality of access points and the wireless terminal, and holding the table.

4. The method in accordance with claim 3, wherein said physical address includes a MAC (Media Access Control) address of the wireless terminal.

5. The method in accordance with claim 2, further comprising the steps of:
receiving a frame from a source wireless terminal by one of the plurality of access points;
referencing the one-hop adjacency table and two-hop adjacency table by the one access point;
determining by the one access point an access point to which the frame should be relayed and a next access point to which the frame should be further transferred;
updating, on a basis of said step of determining, address information of the received frame by the one access point;
referencing the one-hop adjacency table and two-hop adjacency table by the relaying access point; and
updating the address information of the relayed frame by the relaying access point,
whereby the frame sent from the source wireless terminal addressed to a recipient wireless terminal is relayed via the destination access point.

6. The method in accordance with claim 2, further comprising the steps of:
referencing the one-hop adjacency table and two-hop adjacency table;
counting, if there are a plurality of paths having a same number of hops to the destination access point when determining an access point to which the frame should be relayed and a next access point to which the frame should be further transferred, a number of wireless terminals connected to the access points existing on each path; and
relaying the frame via one of the plurality of paths which has a least sum of the number of wireless terminals with priority.

7. The method in accordance with claim 3, further comprising the steps of:
referencing the one-hop adjacency table and two-hop adjacency table;
counting, if there are a plurality of paths having a same number of hops to the destination access point when determining an access point to which the frame should be relayed and a next access point to which the frame should be further transferred, a number of wireless terminals connected to the access points existing on each path; and
relaying the frame via one of the plurality of paths which has a least sum of the number of wireless terminals with priority.

8. A method of acquiring topology in a multi-hop wireless network comprising a plurality of access points, each of the plurality of access points having a function of relaying a frame, comprising the steps of:
transmitting and receiving an inquiry frame and a response frame to and from the plurality of access points to detect a connection status between first one of the plurality of access points and second one of the access points which is adjacent to the first access point;
transferring information on the detected status between the plurality of access points;
detecting, on a basis of the transferred information, third one of the plurality of access points which a radio wave from the first access point can reach in a one-hop way or fourth one of the plurality of access points which the radio wave can reach in a two-hop way;
forming a one-hop adjacency table and a two-hop adjacency table;
selecting a relaying access point which relays a broadcast frame from the first access point to an intended destination access point;
advertising the selected access point to another of the plurality of access points on a broadcast frame;
acquiring topology of the network; and
forming an optimum communication path between any of the plurality of access points.

9. A multi-hop wireless communications system comprising a plurality of access points, wherein each of said plurality of access points comprises:
a transmitter/receiver for transmitting and receiving access point information on an inquiry frame and a response frame;
a path information forming section for using path information of another of said plurality of access points received from said other access point to periodically update the path information of said access point; and
a selector for detecting, on a basis of the path information of said access point, first one of said plurality of access points which a radio wave form said access point can reach in a one-hop way or second one of said plurality of access points which the radio wave can reach in a two-hop way, forming a one-hop adjacency table or a two-hop adjacency table on a basis of information on a physical address of said detected first or second access point, and using the one-hop adjacency table or the two-hop adjacency table to select one of said plurality of access points which relays a broadcast frame from said access point to an intended destination access point of a received frame.

10. A multi-hop wireless communications system comprising a plurality of access points, wherein each of said plurality of access points comprises:
a transmitter/receiver for transmitting and receiving access point information on an inquiry frame and a response frame;
a path information forming section for updating path information of another of said plurality of access points adjacent to said access point on a basis of physical address information included in the response frame received by said transmitter/receiver; and
a selector for detecting, on a basis of the path information, first one of said plurality of access points which a radio wave form said access point can reach in a one-hop way or second one of said plurality of access points which the radio wave can reach in a two-hop way, forming a one-hop adjacency table or a two-hop adjacency table on a basis of information on a physical address of said detected first or second access point, and using the one-hop adjacency table or the two-hop adjacency table to select one of said plurality of access points which relays a broadcast frame from said access point to an intended destination access point of a received frame.

11. The system in accordance with claim 9, wherein said path information forming section of said access point references on a basis of a destination address described in a frame received from a source wireless terminal connected to said access point, the one-hop adjacency table or the two-hop adjacency table, determines one of said plurality of access points to which the frame received should be relayed and a next access point to which the frame relayed should be further transferred, and then updates address information of the received frame, and
said path information forming section of said one access point to which the frame received is relayed references the own one-hop adjacency table or the two-hop adjacency table, and updates the address information of the relayed frame,
whereby the frame is relayed to the destination access point and ultimately to a recipient wireless terminal.

12. The system in accordance with claim 10, wherein said path information forming section of said access point references, on a basis of a destination address described in a frame received from a source wireless terminal connected to said access point, the one-hop adjacency table or the two-hop adjacency table, determines one of said plurality of access points to which the frame received should be relayed and a next access point to which the frame relayed should be further transferred, and then updates address information of the received frame, and
said path information forming section of said one access point to which the frame received is relayed references the own one-hop adjacency table or the two-hop adjacency table, and updates the address information of the relayed frame,
whereby the frame is relayed to the destination access point and ultimately to a recipient wireless terminal.

13. The system in accordance with claim 9, wherein said access point further comprises a counter for counting, if there are a plurality of paths having a same number of hops from said access point to the destination access point when determining an access point which relays the broadcast frame, a number of physical addresses corresponding to a number of wireless terminals connected to the access points existing on each path on a basis of the destination address in the frame received from the wireless terminal,
said transmitter/receiver selecting with priority one of the plurality of paths which has the least sum of the number of wireless terminals counted by said counter to relay the frame to the destination access point and ultimately to the recipient wireless terminal.

14. The system in accordance with claim 10, wherein said access point further comprises a counter for counting, if there are a plurality of paths having a same number of hops from said access point to the destination access point when determining an access point which relays the broadcast frame, a number of physical addresses corresponding to a number of wireless terminals connected to the access points existing on each path on a basis of the destination address in the frame received from the wireless terminal,
said transmitter/receiver selecting with priority one of the plurality of paths which has the least sum of the number of wireless terminals counted by said counter to relay the frame to the destination access point and ultimately to the recipient wireless terminal.
